(19) United States
(12) Patent Application Publication
(10) Pub. No.: US 2018/0157348 A1
(43) Pub. Date: Jun. 7, 2018

(54) Method For Manufacturing Touch Substrate, Touch Substrate And Touch Display Screen

(71) Applicants: BOE Technology Group Co., Ltd., Beijing (CN); Beijing BOE Optoelectronics Technology Co., Ltd., Beijing (CN)

(72) Inventors: Xiuyun CHEN, Beijing (CN); Xibin SHAO, Beijing (CN); Jieqiong WANG, Beijing (CN); Dae Keun YOON, Beijing (CN)

(73) Assignee: Beijing BOE Optoelectronics Technology Co., Ltd., Beijing (CN)

(21) Appl. No.: 15/545,191

(22) PCT Filed: Jan. 6, 2017
(86) PCT No.: PCT/CN2017/070396

§ 371 Date: Jul. 20, 2017

(30) Foreign Application Priority Data
Apr. 20, 2016 (CN) 201610248985.9

(51) Int. Cl. G06F 3/041; G02F 1/1333

(52) U.S. Cl. CPC G06F 3/041; G06F 2203/04103; G02F 1/13338

(57) ABSTRACT

The present disclosure relates to a method for manufacturing a touch substrate. The method includes forming a surface strengthening layer on a surface of a touch mother substrate; cutting the touch mother substrate formed with the surface strengthening layer to form a plurality of touch sub-substrates; and removing the surface strengthening layer at a peripheral region of the touch sub-substrate such that the surface strengthening layer of the touch sub-substrate has an area less than a surface area of the touch sub-substrate and the surface strengthening layer at least covers a display region of the touch sub-substrate so as to form the touch substrate. The present disclosure also relates to a touch substrate manufactured by the above method and a touch display screen including the touch substrate.

### CROSS-REFERENCE TO RELATED APPLICATION

This application is a Section 371 National Stage Application of International Application No. PCT/CN2017/070396, filed on 6 Jan. 2017, which has not yet published and claims priority to Chinese Patent Application No. 201610248985.9, filed with SIPO on Apr. 20, 2016, the contents of which are incorporated herein by reference in their entirety.

### BACKGROUND OF THE DISCLOSURE

### Field of the Disclosure

The present disclosure relates to a method for manufacturing a touch substrate, and the touch substrate manufactured by the method and a touch display screen.

### Description of the Related Art

In recent years, as display screens need touch functions, touch substrates such as One Glass Solution (OGS) touch substrates are applied more and more widely in the display screens.

In a touch display screen including the OGS touch substrate, in order to prevent the OGS touch substrate from being destroyed due to external force impacts, surface strengthening typically needs to be applied to the touch substrate. Two types of surface strengthening methods are known. In one of them, a large size mother substrate is cut into sub-substrates and then full surface strengthening is applied to the sub-substrates. In the other method for applying surface strengthening to the touch substrate, full surface strengthening is at first applied to the mother substrate to form a compressive stress layer on the mother substrate, and then patterning process for touch electrodes is performed on the mother substrate and subsequently, the mother substrate is cut into sub-substrates.

### SUMMARY

In accordance with an aspect of the present disclosure, it provides a method for manufacturing a touch substrate, the method comprising: forming a surface strengthening layer on a surface of a touch mother substrate; cutting the touch mother substrate formed with the surface strengthening layer to form a plurality of touch sub-substrates; and removing the surface strengthening layer at a peripheral region of the touch sub-substrate such that the surface strengthening layer of the touch sub-substrate has an area less than a surface area of the touch sub-substrate and the surface strengthening layer at least covers a display region of the touch sub-substrate so as to form the touch substrate.

In an embodiment, the surface strengthening layer at the peripheral region of the touch sub-substrate is removed by a grinding process.

In an embodiment, the surface strengthening layer comprises a compressive stress layer.

In an embodiment, the touch mother substrate is patterned to form touch electrodes before cutting the touch mother substrate formed with the surface strengthening layer to form a plurality of touch sub-substrates.

In an embodiment, the surface strengthening layer is provided to have a thickness of 40 μm.

In accordance with another aspect of the present disclosure, it provides a touch substrate manufactured by the method described as above.

In an embodiment, the surface strengthening layer has a thickness of 40 μm.

In an embodiment, the touch substrate is a One Glass Solution touch substrate.

In accordance with another aspect of the present disclosure, it provides a touch display screen comprising: the touch substrate described as above; and a display panel, wherein the display panel and the touch substrate are bonded to each other by adhesives.

In an embodiment, the touch display screen further comprises a frame which surrounds periphery of the touch substrate and the display panel to further fix the touch substrate and the display panel.

In an embodiment, the adhesives are optical transparent resins.

### BRIEF DESCRIPTION OF THE DRAWINGS

FIG. 1 is a flow chart of a method for manufacturing a touch substrate according to an embodiment of the present disclosure;

FIG. 2 is a schematic view showing touch substrates formed in respective steps of the method for manufacturing the touch substrate according to an embodiment of the present disclosure;

FIG. 3 is a schematic top view of the touch mother substrate and touch sub-substrates according to an embodiment of the present disclosure;

FIG. 4 is a schematic cross-sectional view of an OGS touch display screen according to an embodiment of the present disclosure; and

FIG. 5 is a schematic top view of an OGS touch display screen according to an embodiment of the present disclosure.

### DETAILED DESCRIPTION OF PREFERRED EMBODIMENTS OF THE DISCLOSURE

Below, technical solutions of embodiments of the present disclosure will be described clearly and completely in conjunction with drawings for the embodiments. Apparently, the described embodiments are only a part of all embodiments of the present disclosure, rather than all of the embodiments. From the embodiments of the present disclosure, all other embodiments which can be obtained by the person skilled in the art without any inventive efforts belong to the scope of the present disclosure.

As discussed in the background part of the present disclosure, the former of the two types of surface strengthening methods has the drawback that on one hand, due to large amount of the sub-substrates, the period by which the strengthening process is performed may be increased significantly, and on the other hand as the strengthened small size sub-substrates also need to carry out patterning process for touch electrodes subsequently, the time and cost of patterning process may be increased. The latter of the two types of surface strengthening methods has the drawback that such method may save time and cost of carrying out the surface strengthening and patterning process. However, an operation of cutting the mother substrate in this method may cause numerous edge crackles at cutting edges. Thus, the OGS touch display screen produced by this method tends to be broken due to impact of external force. It has risk, for example when products are assembled, transported and used by customers.

Furthermore, the conventional OGS touch substrate is adhered to a liquid crystal module only by optical transparent resin and the OGS touch substrate is supported only by the optical transparent resin without any other strengthening means. Thus, the conventional OGS touch substrate is typically only suitable for electronic products with small size less than 27 inches and fails to satisfy the requirements for providing large size and super large size display screens.

In accordance with the generic concept of the present disclosure, it provides a method for manufacturing a touch substrate, the method comprising following steps of: forming a surface strengthening layer on a surface of a touch mother substrate; cutting the touch mother substrate formed with the surface strengthening layer to form a plurality of touch sub-substrates; and removing the surface strengthening layer at a peripheral region of the touch sub-substrate such that the surface strengthening layer of the touch sub-substrate has an area less than a surface area of the touch sub-substrate and the surface strengthening layer at least covers a display region of the touch sub-substrate so as to form the touch substrate.

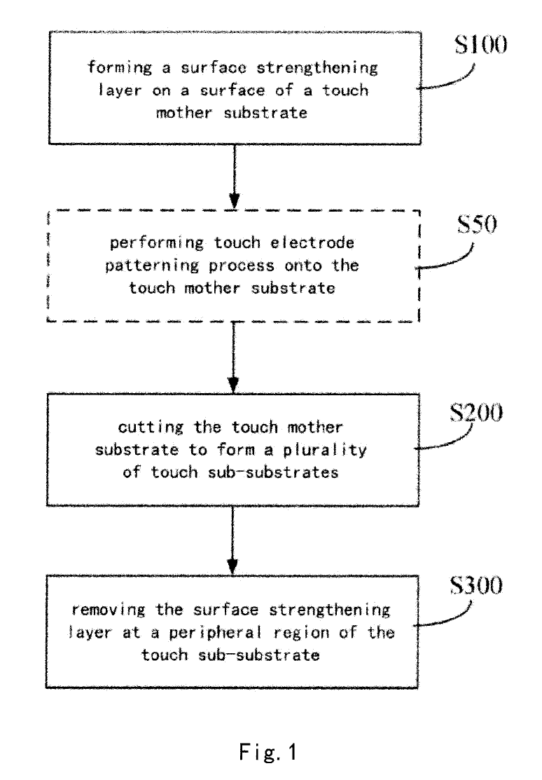

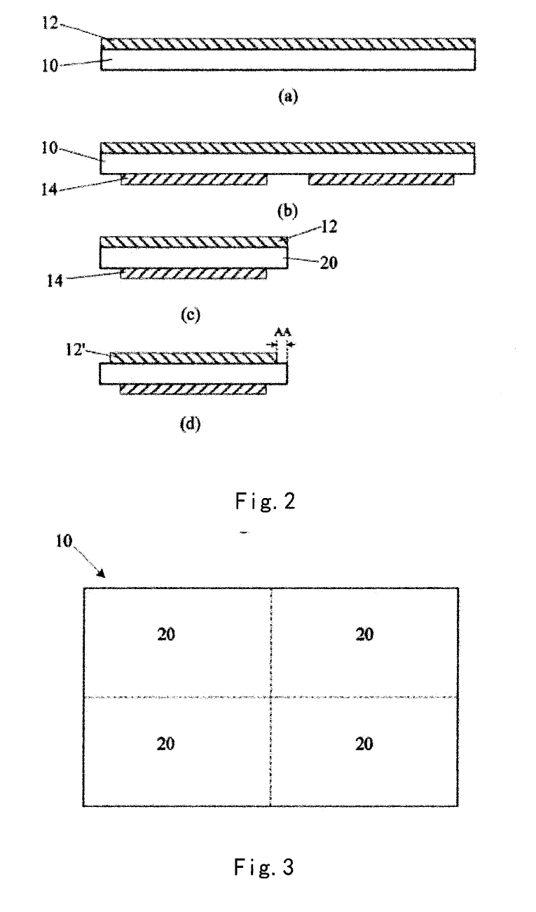

FIG. 1 is a flow chart of a method for manufacturing a touch substrate according to an embodiment of the present disclosure; FIG. 2 is a schematic view showing touch substrates formed in respective steps of the method for manufacturing the touch substrate according to an embodiment of the present disclosure; and FIG. 3 is a schematic top view of the touch mother substrate and touch sub-substrates according to an embodiment of the present disclosure.

As shown in FIG. 1, in the step S100, a surface strengthening layer is formed on a surface of a touch mother substrate; in the step S200, the touch mother substrate formed with the surface strengthening layer is cut to form a plurality of touch sub-substrates; in the step S300, the surface strengthening layer at a peripheral region of the touch sub-substrate is removed such that the surface strengthening layer of the touch sub-substrate has an area less than a surface area of the touch sub-substrate and the surface strengthening layer at least covers a display region of the touch sub-substrate. For example, with reference to FIG. 2 and FIG. 3, the surface strengthening layer 12 is formed on a surface of a touch mother substrate 10, as shown in FIG. 2(a). The touch mother substrate 10 formed with the surface strengthening layer 12 is cut along a dashed line in FIG. 3 to form a plurality of touch sub-substrates 20, as shown in FIG. 2(c). The surface strengthening layer 12 at a peripheral region AA of the touch sub-substrate 20 is removed such that the surface strengthening layer 12′ of the touch sub-substrate 20 has an area less than a surface area of the touch sub-substrate 20 and the surface strengthening layer 12′ at least covers a display region of the touch sub-substrate, as shown in FIG. 2(d).

In particular, in the step S300, the surface strengthening layer at the peripheral region of the touch sub-substrate is removed by a grinding process. The surface strengthening layer may be a compressive stress layer.

In accordance with an embodiment, as shown in dashed block in FIG. 1, the method further includes the step S50 of applying a touch electrode patterning process onto the touch mother substrate before the step S200 of cutting the touch mother substrate formed with the surface strengthening layer to form a plurality of touch sub-substrates. In this way, the touch electrode patterning process may be applied to the touch sub-substrate in batches. For example, as shown in FIG. 2(b), the touch electrode patterning process may be applied to the touch mother substrate 10 to form a touch electrode pattern 14.

As an example, the surface strengthening layer is provided to have a thickness of 40 μm. Correspondingly, in the step S300, the depth of the removed surface strengthening layer at the peripheral region of the touch sub-substrate is also 40 μm. That is, the surface strengthening layer at the peripheral region of the touch sub-substrate is removed completely.

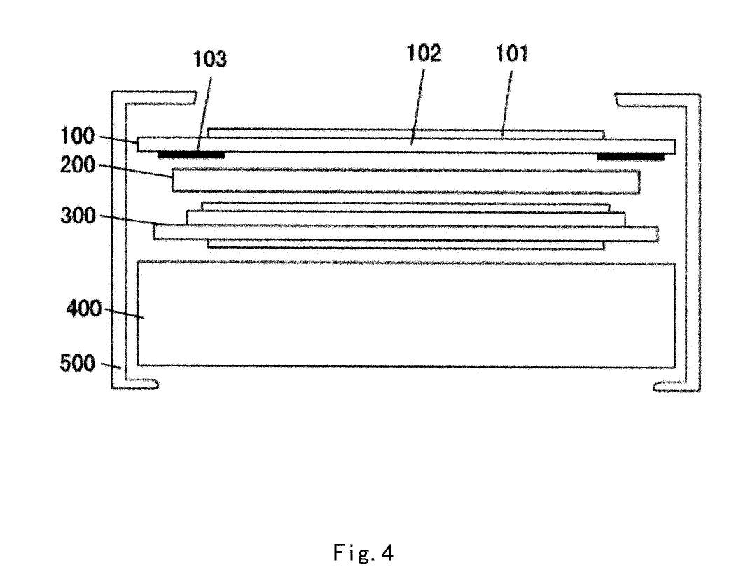

In accordance with another aspect of the present disclosure, it provides a touch substrate manufactured by the above method and a touch display screen including the touch substrate. FIG. 4 is a schematic cross sectional view of a large size OGS touch display screen according to an embodiment of the present disclosure. The touch display screen includes: the touch substrate 100, which includes a sub-substrate 102, a surface strengthening layer 101 arranged on a/one surface of the sub-substrate 102 and a black matrix 103 arranged on the other surface of the sub-substrate 102; and a display panel 300. The display panel 300 is bonded to the touch substrate 100 via adhesives 200. The display panel 300 may include a plurality of layers such as a polarizer layer, an optical filter layer. The area of the surface strengthening layer 101 is less than the area of the touch substrate 100, and the surface strengthening layer 101 at least covers the display region completely. The surface strengthening layer 101 may be a compressive stress layer. The thickness of the surface strengthening layer 101 is typically 40 μm. The display panel 300 is bonded to the side of the touch substrate 100 with the black matrix 103 via adhesives 200. The adhesives may be optical transparent resins.

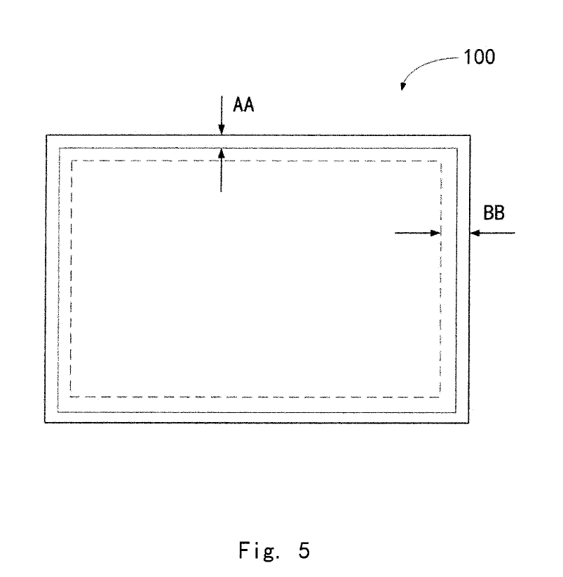

FIG. 5 is a schematic top view of an OGS touch substrate 100 according to an embodiment of the present disclosure. As shown in FIG. 5, the black matrix 103 covers a non-display region BB of the touch substrate 100. The peripheral region AA of the surface strengthening layer 101 is removed by a grinding process. The width of the peripheral region AA is less than the width of the non-display region BB. Thus, the area of the surface strengthening layer 101 is less than the area of the touch substrate 100 and the surface strengthening layer 101 at least covers the display region (i.e., the region enclosed by the dashed line in FIG. 5) completely. As the peripheral region AA of the surface strengthening layer 101 is removed by a grinding process, the stress at the periphery for the crackles formed due to cutting is released only in a small peripheral region to avoid the integral cracking of the touch substrate. In this way, it is ensured that there is normal touch function within the touch region of the display region in a central portion.

In addition, as shown in FIG. 4, the touch display screen may further include a backlight source 400 arranged on the side of the display panel 300 in opposite to the touch substrate 100.

Furthermore, according to an embodiment of the present disclosure, as illustrated in FIG. 4, the touch display screen may further include a frame 500 which surrounds periphery of combination of the touch substrate 100, the display panel 300 and the backlight source 400 and covers the non-display region at the periphery of the touch substrate 100. In this way, the protection of the periphery of the touch substrate 100 is increased to reduce direct impact of the external force to lateral sides of the touch substrate 100. At the same time, the touch substrate 100 does not only subject to adhesive fixing effects of the optical transparent resin glue 200, but also subject to the support effects of the frame 500. Thus, it improves the stability of assembling the touch substrate 100 effectively such that the size of the touch substrate 100 may be enhanced significantly.

In an embodiment of the present disclosure, the touch substrate may be a One Glass Solution touch substrate.

In the touch substrate according to the embodiment of the present disclosure, as the peripheral region of the surface strengthening layer is removed by a grinding process, the stress at the periphery for the crackles is released only in a small peripheral region to avoid the integral cracking of the touch substrate. In this way, it is ensured that there is normal touch function within the display region in central portion of the panel.

And, in accordance with the embodiment of the present disclosure, at first, the surface strengthening layer is formed on the surface of the touch mother substrate and/or the touch electrode patterning process is applied to the touch mother substrate; then the touch mother substrate formed with the surface strengthening layer is cut to form a plurality of touch sub-substrates. Thus, the time and costs of performing surface strengthening and patterning process may be saved significantly such that the touch display screen may be produced at low cost and large batches.

Comparison between the conventional touch substrate and the touch substrate according to the embodiment of the present disclosure in relevant performances is listed in table 1 below.

TABLE 1
comparison in fragment percent and crackles

| | | Touch substrate according to the |
|---|---|---|
| Performance Parameters | Conventional touch substrate | present disclosure |
| fragment percent in adhering | 16% (penetration crackles occur) | 2% (local crackles occur) |
| operation | | |
| fragment percent in assembling | 31% (penetration crackles occur) | <1% (peripheral crackles occur) |
| operation | | |
| fragment percent in transport | 10% (penetration crackles occur) | <1% (local crackles occur) |

It can be determined from the above table that the ratio (called as fragment percent) of the number of the broken panels to the total number of the panels of touch substrate in the present disclosure is significantly lower than the conventional touch substrate, whether in the adhering operation, in the assembling operation or in transport. In addition, the crackles that occur in the conventional touch substrate are all penetration crackles, which have very large destructive effects and tend to cause the whole panel to be broken. In contrast, all of the crackles produced on the touch substrate according to the present disclosure are small local crackles and concentrated at periphery without affecting the display region of the central portion. It does not tend to cause the whole panel to be broken.

For the method for manufacturing the touch substrate according to the embodiment of the present disclosure and the touch substrate and display screen manufactured by the method, as the surface strengthening layer at the peripheral region of the touch substrate is removed to separate the peripheral region from the display region such that the stress at the periphery for the crackles is released only in a small peripheral region to avoid the integral cracking of the touch substrate. In this way, it is ensured that there is normal touch function within the display region in a central portion of the panel.

Specific embodiments of the present disclosure have been explained above. However, it should be understood that the above described embodiments are exemplary embodiments of the present disclosure, instead of limiting the present disclosure. All of modifications, alternatives and improvements made without departing from the principles and spirit of the disclosure should fall within the protection scope of the present disclosure.

It should be noted that the phrases of “include” and “comprise” do not exclude other members or steps and the phrases of “an” or “a” does not exclude more than one. In addition, any reference numerals in claims should not be understood as limitations to the scope of the present disclosure.

1. A method for manufacturing a touch substrate, comprising:
forming a surface strengthening layer on a surface of a touch mother substrate;
cutting the touch mother substrate formed with the surface strengthening layer to form a plurality of touch sub-substrates; and
removing the surface strengthening layer at a peripheral region of the touch sub-substrate such that the surface strengthening layer of the touch sub-substrate has an area less than a surface area of the touch sub-substrate and the surface strengthening layer at least covers a display region of the touch sub-substrate so as to form the touch substrate.

2. The method according to claim 1, wherein the surface strengthening layer at the peripheral region of the touch sub-substrate is removed by a grinding process.

3. The method according to claim 1, wherein the surface strengthening layer comprises a compressive stress layer.

4. The method according to claim 1, wherein the touch mother substrate is patterned to form touch electrodes before cutting the touch mother substrate formed with the surface strengthening layer to form the plurality of touch sub-substrates.

5. The method according to claim 1, wherein the surface strengthening layer is provided to have a thickness of 40 μm.

6. A touch substrate manufactured by the method according claim 1.

7. The touch substrate according to claim 6, wherein the surface strengthening layer has a thickness of 40 μm.

8. The touch substrate according to claim 6, wherein the touch substrate is a One Glass Solution touch substrate.

9. A touch display screen comprising:
the touch substrate according to claim 6; and
a display panel,
wherein the display panel and the touch substrate are bonded to each other by adhesives.

10. The touch display screen according to claim 9, wherein the touch display screen further comprises a frame which surrounds periphery of the touch substrate and the display panel to further fix the touch substrate and the display panel.

11. The touch display screen according to claim 9, wherein the adhesives are optical transparent resins.

12. The method according to claim 2, wherein the surface strengthening layer comprises a compressive stress layer.

13. The method according to claim 12, wherein the touch mother substrate is patterned to form touch electrodes before cutting the touch mother substrate formed with the surface strengthening layer to form the plurality of touch sub-substrates.

14. The method according to claim 13, wherein the surface strengthening layer is provided to have a thickness of 40 μm.

15. The touch substrate according to claim 6, wherein the surface strengthening layer at the peripheral region of the touch sub-substrate is removed by a grinding process.

16. The touch substrate according to claim 6, wherein the surface strengthening layer comprises a compressive stress layer.

17. The touch substrate according to claim 6, wherein the touch mother substrate is patterned to form touch electrodes before cutting the touch mother substrate formed with the surface strengthening layer to form the plurality of touch sub-substrates.

18. The touch display screen according to claim 9, wherein the surface strengthening layer has a thickness of 40 μm.

19. The touch display screen according to claim 9, wherein the touch substrate is a One Glass Solution touch substrate.

20. The touch display screen according to claim 18, wherein the touch substrate is a One Glass Solution touch substrate.
